(19) United States
(12) Patent Application Publication
(10) Pub. No.: US 2018/0213115 A1
(43) Pub. Date: Jul. 26, 2018

(54) Document Printing System That Includes Online Payment Service and Image Forming Apparatus, and Recording Medium

(71) Applicant: Kyocera Document Solutions Inc., Osaka (JP)

(72) Inventors: Zhenyu Sun, Osaka (JP); Tatsuya Hiwatari, Osaka (JP); Yumi Nakagoshi, Osaka (JP)

(21) Appl. No.: 15/878,407

(22) Filed: Jan. 23, 2018

(30) Foreign Application Priority Data
Jan. 24, 2017 (JP) 2017-009984

(51) Int. Cl. H04N 1/34; G06F 3/12; G06Q 20/32; G06Q 30/02; G06F 8/61; G06F 13/10

(52) U.S. Cl. CPC H04N 1/34; G06F 3/1272; G06F 3/1225; G06F 3/1292; G06F 3/1287; G06Q 20/3274; G06Q 30/0283; G06F 8/61; G06F 13/102; H04N 2201/0094; G06Q 20/325

(57) ABSTRACT

A document printing system includes an image forming apparatus, a print data management unit, a charge calculator, and a payment code notification unit. The image forming apparatus includes a print device and a driver installer. The driver installer installs a printer driver onto an external electronic device. The charge calculator calculates a charge based on the print data managed by the print data management unit. The payment code notification unit notifies a payment code issued by an online payment service to the charge calculated by the charge calculator. The image forming apparatus includes a document printing unit that executes a print job with the print device based on the print data managed by the print data management unit when the charge has been paid via the online payment service using the payment code notified by the payment code notification unit.

### INCORPORATION BY REFERENCE

This application is based upon, and claims the benefit of priority from, corresponding Japanese Patent Application No. 2017-009984, filed in the Japan Patent Office on Jan. 24, 2017, and the entire contents of which are incorporated herein by reference.

### BACKGROUND

Unless otherwise indicated herein, the description in this section is not prior art to the claims in this application and is not admitted to be prior art by inclusion in this section.

There has been known a typical system that includes a coin vendor, which ensures a payment for a charge by cash, and a copier. The system executes the real-time payment for the charge by the coin vendor at execution of a copy job by the copier.

### SUMMARY

A document printing system according to one aspect of the disclosure includes an image forming apparatus, a print data management unit, a charge calculator, and a payment code notification unit. The image forming apparatus includes a print device and a driver installer. The driver installer installs a printer driver onto an external electronic device, and the printer driver generates print data of a document. The print data management unit manages the print data generated by the printer driver. The charge calculator calculates a charge based on the print data managed by the print data management unit. The payment code notification unit notifies a payment code issued by an online payment service to the charge calculated by the charge calculator. The image forming apparatus includes a document printing unit that executes a print job with the print device based on the print data managed by the print data management unit when the charge has been paid via the online payment service using the payment code notified by the payment code notification unit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a block diagram illustrating a document printing system according to one embodiment of the disclosure.

FIG. 2 is a block diagram illustrating a user terminal according to the one embodiment.

FIG. 3 is a block diagram illustrating an electronic device according to the one embodiment.

FIG. 4 is a block diagram illustrating an MFP according to the one embodiment.

FIG. 5 illustrates exemplary print data management information illustrated in FIG. 4.

FIG. 6 is a block diagram illustrating a computer according to the one embodiment.

FIG. 7 illustrates exemplary MFP management information illustrated in FIG. 6.

FIG. 8 illustrates exemplary payment code management information illustrated in FIG. 6.

FIG. 9 illustrates exemplary information stored by an online payment service illustrated in FIG. 1.

FIG. 10 illustrates exemplary payment code management information illustrated in FIG. 9.

FIG. 11 illustrates an operation of the document printing system according to the one embodiment when a printer driver is installed on the electronic device.

FIG. 12 illustrates an operation of the document printing system according to the one embodiment when a new document is stored in the MFP.

FIG. 13 illustrates an operation of the document printing system according to the one embodiment until the MFP to which an instruction of an execution of a document print job has been input displays a two-dimensional code.

FIG. 14 illustrates an operation of the document printing system according to the one embodiment from when the user terminal reads the two-dimensional code until the MFP terminates the execution of the document print job.

FIG. 15 illustrates an exemplary payment screen displayed on a display of the user terminal according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure by referring to the drawings.

First, a description will be given of a configuration of a document printing system according to the embodiment.

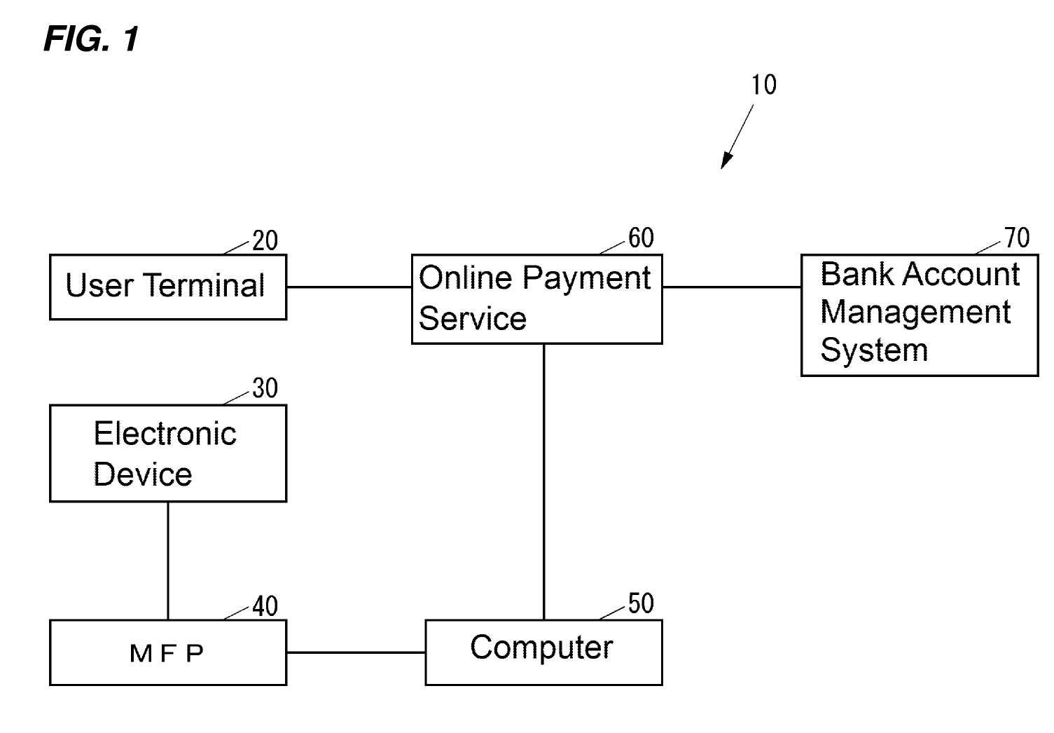

FIG. 1 is a block diagram illustrating a document printing system 10 according to the embodiment.

As illustrated in FIG. 1, the document printing system 10 includes a user terminal 20 used by a user, an electronic device 30 used by a user, a multifunction peripheral (MFP) 40 as an image forming apparatus, a computer 50, an online payment service 60 as a cloud service that executes online payments, and a bank account management system 70 that manages bank accounts.

The MFP 40 is installable at various facilities, for example, commercial facilities such as a convenience store and an eating place, and public facilities such as a university. The MFP 40 is a device that executes a print job accepted from the electronic device 30 based on print data of a document corresponding to a payment for a charge by the user.

In addition to the process regarding the charge of the MFP 40, the computer 50 may be configured to execute a process regarding a charge of at least one MFP similar to the MFP 40.

The online payment service 60 and the bank account management system 70 are cloud services and are systems achieved by servers such as cloud servers.

The user terminal 20 and the online payment service 60 are communicable via a network such as the Internet.

The electronic device 30 and the MFP 40 are configured to execute wireless communication directly (hereinafter referred to as “direct wireless communication”) without being via another communication device such as a router. The direct wireless communication is, for example, Wi-Fi Direct (registered trademark).

The MFP 40 and the computer 50 are enabled for communicating via a network such as a local area network (LAN) or the Internet, or are enabled for communicating directly, by wired or wireless communications rather than via a network.

The computer 50 and the online payment service 60 are enabled for communicating via the network such as the Internet.

The online payment service 60 and the bank account management system 70 are enabled for communicating via the network such as the Internet.

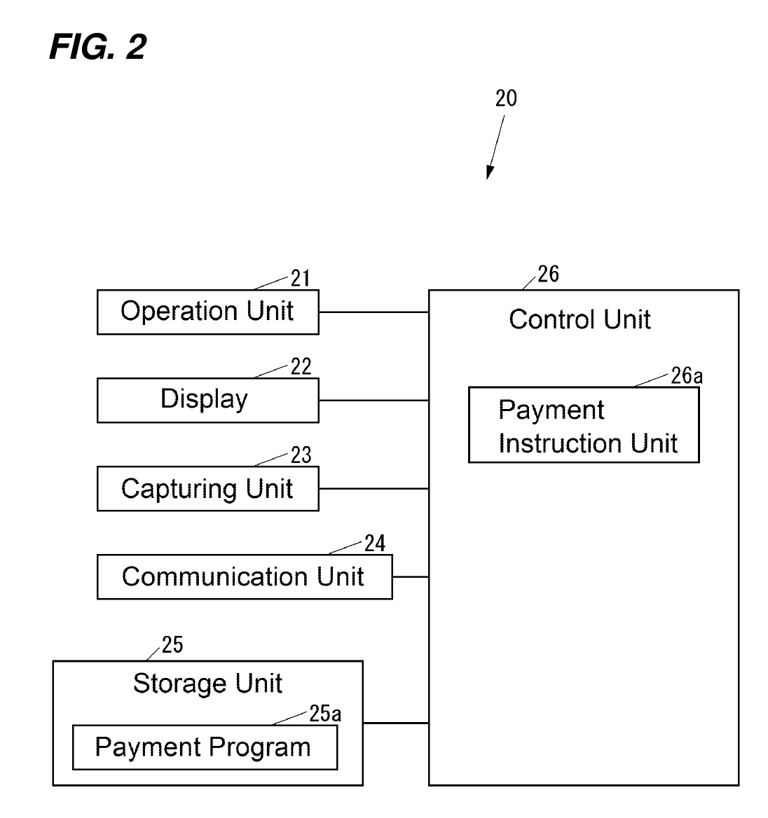

FIG. 2 is a block diagram illustrating the user terminal 20.

As illustrated in FIG. 2, the user terminal 20 includes an operation unit 21, a display 22, a capturing unit 23, a communication unit 24, a storage unit 25, and a control unit 26. The operation unit 21 is an input device such as a button through which various operations are input. The display 22 is a display device such as a liquid crystal display (LCD) that displays various kinds of information. The capturing unit 23 is a capturing device such as a camera. The communication unit 24 is a communication device that executes communications with an external device via the network or directly without being via the network by the wired or wireless communications. The storage unit 25 is a non-volatile storage device such as a semiconductor memory that stores various pieces of information. The control unit 26 controls the entire user terminal 20. The user terminal 20 may be a portable terminal such as a smart phone and a tablet.

The storage unit 25 stores a payment program 25a for payment by the online payment service 60 (see FIG. 1). The payment program 25a may be installed onto the user terminal 20 at a production stage of the user terminal 20, may be additionally installed from an external storage medium such as a universal serial bus (USB) memory to the user terminal 20, or may be additionally installed from the network to the user terminal 20.

The control unit 26 includes, for example, a central processing unit (CPU), a read-only memory (ROM) that stores programs and various data, and a random-access memory (RAM) used as a work area for the CPU. The CPU executes the programs stored in the ROM or the storage unit 25.

The control unit 26 executes the payment program 25a to achieve a payment instruction unit 26a that instructs the online payment service 60 to execute the payment.

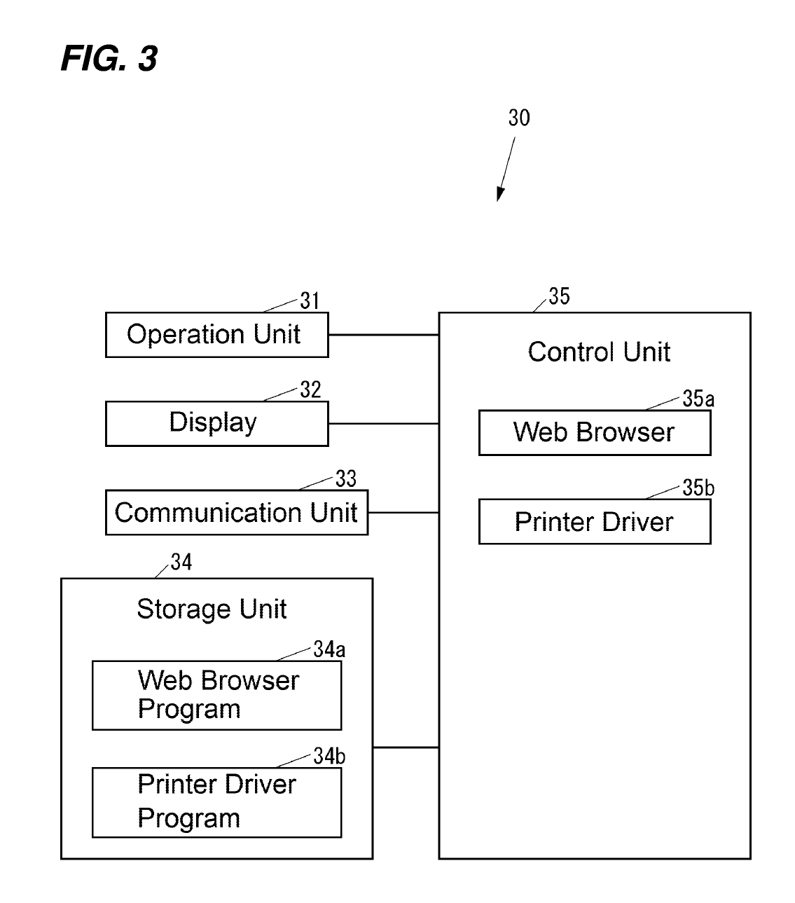

FIG. 3 is a block diagram illustrating the electronic device 30.

As illustrated in FIG. 3, the electronic device 30 includes an operation unit 31, a display 32, a communication unit 33, a storage unit 34, and a control unit 35. The operation unit 31 is an input device such as a keyboard and a computer mouse through which various operations are input. The display 32 is a display device such as the LCD that displays various kinds of information. The communication unit 33 is a communication device that executes communications with the external device via the network or directly without being via the network by the wired or wireless communications. The storage unit 34 is a non-volatile storage device such as the semiconductor memory and a hard disk drive (an HDD) that stores various pieces of information. The control unit 35 controls the entire electronic device 30. The electronic device 30 may be configured of a portable terminal such as a laptop personal computer (PC), a smart phone, and a tablet.

The storage unit 34 stores a web browser program 34a. The web browser program 34a may be installed onto the electronic device 30 at a production stage of the electronic device 30, may be additionally installed from an external storage medium such as the USB flash drive, a compact disk (CD), and a digital versatile disk (DVD) to the electronic device 30, or may be additionally installed from the network to the electronic device 30.

The storage unit 34 is configured to store a printer driver program 34b.

The control unit 35 includes, for example, the CPU, the ROM that stores programs and various data, and the RAM used as the work area for the CPU. The CPU executes the programs stored in the ROM or the storage unit 34.

The control unit 35 executes the web browser program 34a to achieve a web browser 35a.

The control unit 35 executes the printer driver program 34b to achieve a printer driver 35b.

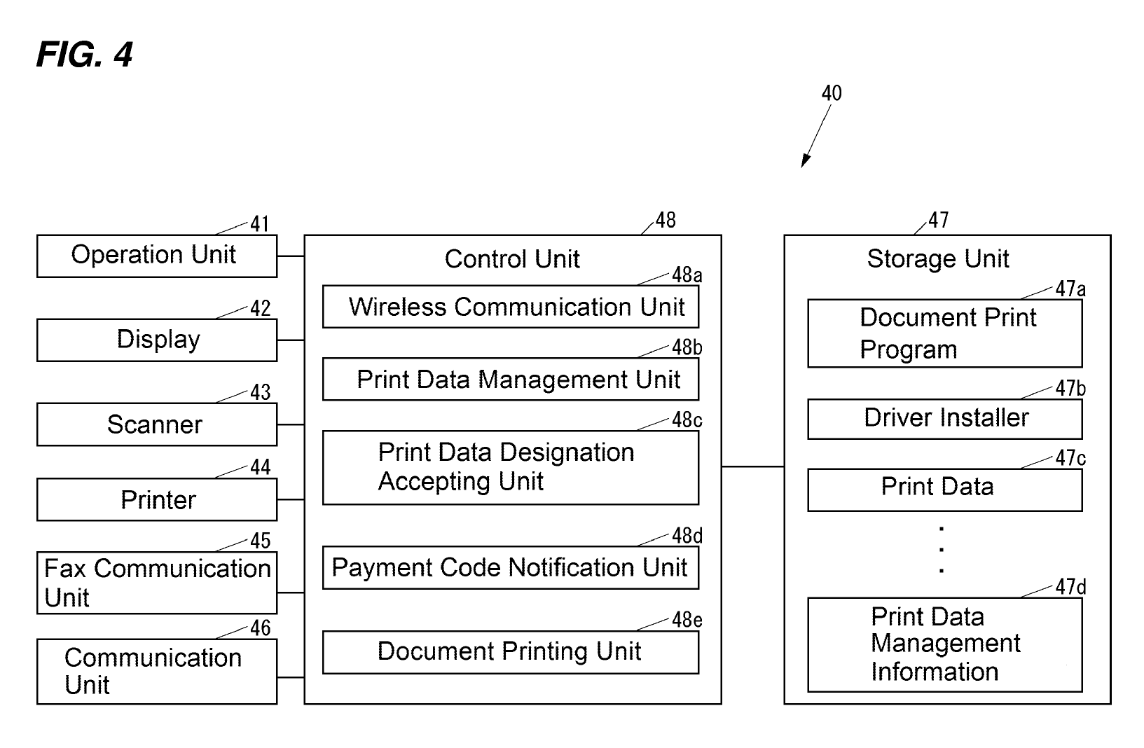

FIG. 4 is a block diagram illustrating the MFP 40.

As illustrated in FIG. 4, the MFP 40 includes an operation unit 41, a display 42, a scanner 43, a printer 44, a fax communication unit 45, a communication unit 46, a storage unit 47, and a control unit 48. The operation unit 41 is an input device such as a button through which various operations are input. The display 42 is a display device such as the LCD that displays various kinds of information. The scanner 43 is a reading device that reads an image from a document. The printer 44 is a print device that prints the image on the recording medium such as a paper sheet. The fax communication unit 45 is a fax device that executes fax communications with an external facsimile device (not illustrated) via a communication line such as a dial-up line. The communication unit 46 is a communication device that executes communications with the external device via the network or directly without being via the network by the wired or wireless communications. The storage unit 47 is a non-volatile storage device such as the semiconductor memory and the HDD that store various pieces of information. The control unit 48 controls the entire MFP 40.

The storage unit 47 stores a document print program 47a for executing a document print job. The document print program 47a may be installed onto the MFP 40 at production stage of the MFP 40, may be additionally installed from an external storage medium such as the USB flash drive to the MFP 40, or may be additionally installed from the network to the MFP 40.

The storage unit 47 stores a driver installer 47b for an installation of a printer driver for generating print data of a document to an external electronic device.

The storage unit 47 is configured to store print data 47c of the document. As the document, documents of various formats, for example, a portable document format (PDF) document, a Microsoft (registered trademark) Word document, a Microsoft Excel (registered trademark) document, a Microsoft PowerPoint (registered trademark) document, a tagged image file format (TIFF) document, and a Joint Photographic Experts Group (JPEG) document are employable. The document includes a print setting of the document itself in some cases. The print setting includes, for example, a setting of the number of copies to be printed, a setting of a size of a recording medium to be printed, a setting of any of a monochrome printing and a color printing, and a setting of any of a duplex printing and a single-side printing.

The storage unit 47 is configured to store print data management information 47d for managing the print data 47c.

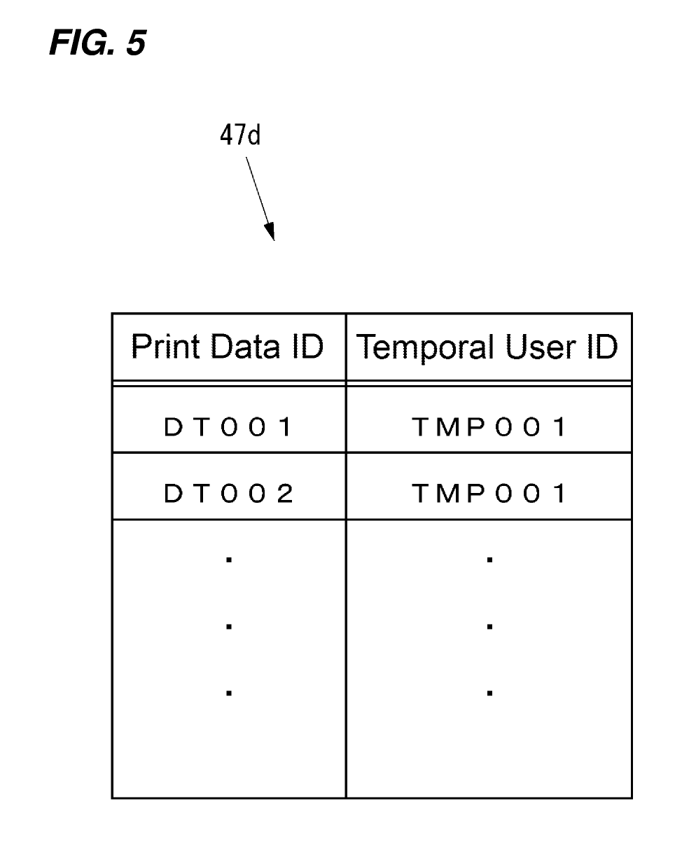

FIG. 5 illustrates the exemplary print data management information 47d.

As illustrated in FIG. 5, the print data management information 47d is information where a print data ID as identification information of the print data 47c, a name of a temporal user (hereinafter referred to as “a temporal user name”) and identification information (hereinafter referred to as “a temporal user ID”) such as a personal identification number (PIN) code are matched.

The control unit 48 illustrated in FIG. 4 includes, for example, the CPU, the ROM that stores the programs and various data, and the RAM used as the work area for the CPU. The CPU executes the programs stored in the ROM or the storage unit 47.

The control unit 48 executes the document print program 47a to achieve a wireless communication unit 48a, a print data management unit 48b, a print data designation accepting unit 48c, a payment code notification unit 48d, and a document printing unit 48e. The wireless communication unit 48a is configured to execute the direct wireless communication with the external electronic device. The print data management unit 48b manages the print data for each job. The print data designation accepting unit 48c accepts a designation of the print data 47c matched to the temporal user ID. The payment code notification unit 48d notifies the payment code issued to the charge, which is calculated by the computer 50 (see FIG. 1), by the online payment service 60 (see FIG. 1). The document printing unit 48e executes the print job by the printer 44 based on the print data when the charge is paid using the payment code notified from the payment code notification unit 48d via the online payment service 60.

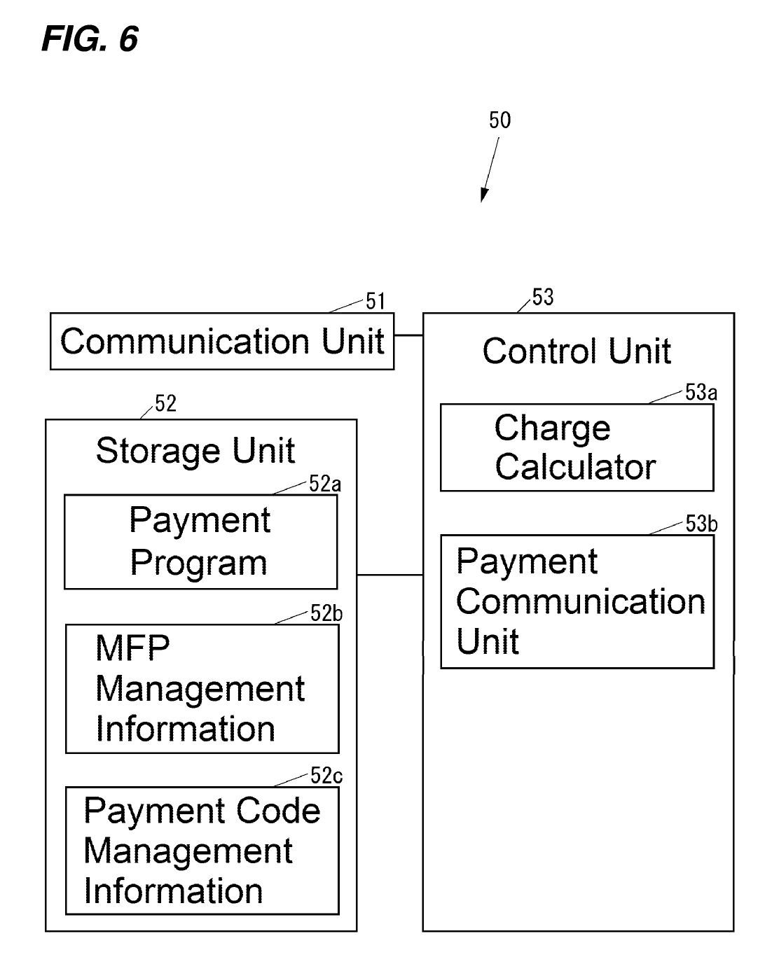

FIG. 6 is a block diagram illustrating the computer 50.

As illustrated in FIG. 6, the computer 50 includes a communication unit 51, a storage unit 52, and a control unit 53. The communication unit 51 is a communication device that executes communications with the external device via the network or directly without being via the network by the wired or wireless communications. The storage unit 52 is the non-volatile storage device such as the semiconductor memory and the HDD that store various pieces of information. The control unit 53 controls the entire computer 50. The computer 50 may be configured of, for example, a PC.

The storage unit 52 stores a payment program 52a for payment by the online payment service 60 (see FIG. 1). The payment program 52a may be installed onto the computer 50 at a production stage of the computer 50, may be additionally installed from an external storage medium such as the USB flash drive, the CD, and the DVD to the computer 50, or may be additionally installed from the network to the computer 50.

The storage unit 52 stores MFP management information 52b to manage the MFP.

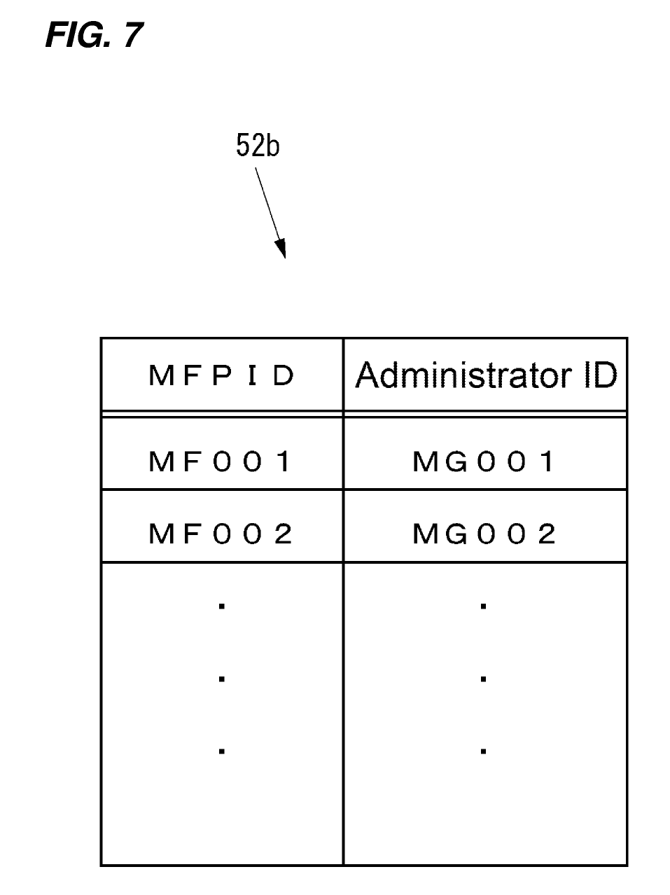

FIG. 7 illustrates the exemplary MFP management information 52b.

As illustrated in FIG. 7, the MFP management information 52b is information where MFPIDs as identification information of the MFPs are matched to administrator IDs as identification information of administrators of the MFPs.

As illustrated in FIG. 6, the storage unit 52 can store payment code management information 52c to manage the payment code issued by the online payment service 60 (see FIG. 1).

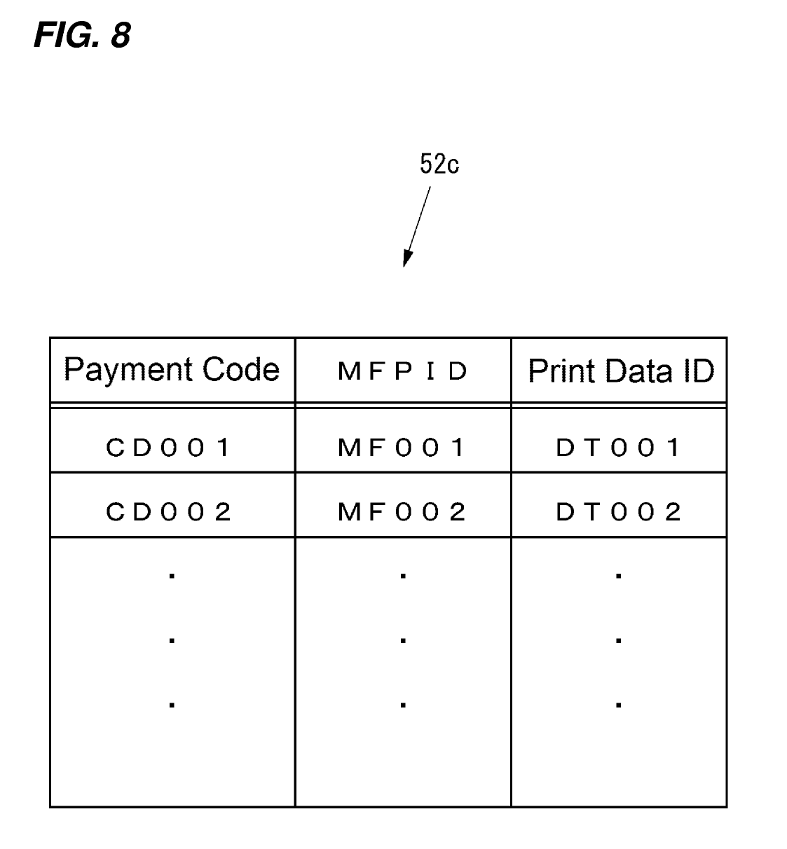

FIG. 8 illustrates the exemplary payment code management information 52c.

As illustrated in FIG. 8, the payment code management information 52c is information where the payment codes, the MFPIDs, and the print data IDs as identification information of the print data are matched.

The control unit 53 illustrated in FIG. 6 includes, for example, the CPU, the ROM that stores programs and various data, and the RAM used as the work area for the CPU. The CPU executes the programs stored in the ROM or the storage unit 52.

The control unit 53 executes the payment program 52a to achieve a charge calculator 53a and a payment communication unit 53b. The charge calculator 53a calculates the charge based on the print data. The payment communication unit 53b executes communications for the payment by the online payment service 60.

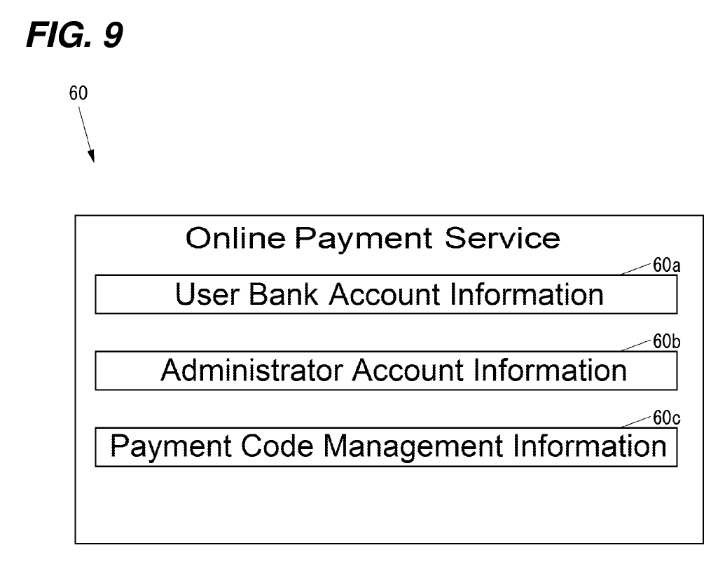

FIG. 9 illustrates exemplary information stored by the online payment service 60.

As illustrated in FIG. 9, the online payment service 60 stores user bank account information 60a and administrator account information 60b. The user bank account information 60a shows information on the bank account of the user for each user ID as the identification information of the user. The administrator account information 60b shows information on the account of the administrator of the MFP 40 for each administrator ID.

The user bank account information 60a includes information on the bank account of the user such as a name of the bank that manages the bank account of the user and the account number of the bank account. For example, the user can register the information on the bank account of the user on the user bank account information 60a in the online payment service 60 via the payment program 25a via the operation unit 21 of the user terminal 20.

For example, the administrator can register the information on the account of the administrator on the administrator account information 60b in the online payment service 60 via the Internet via any PC. The account of the administrator is the account managed by the online payment service 60, not the bank account.

The online payment service 60 can store payment code management information 60c to manage the payment code.

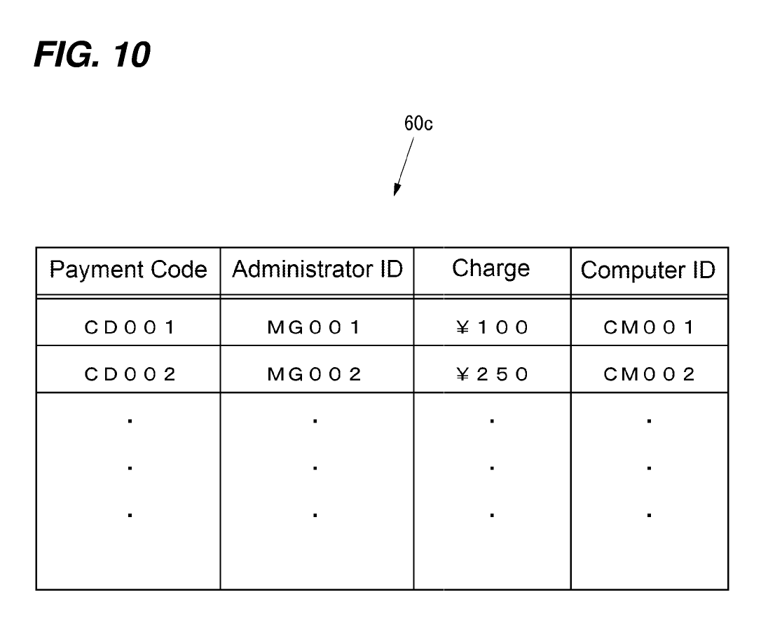

FIG. 10 illustrates the exemplary payment code management information 60c.

As illustrated in FIG. 10, the payment code management information 60c is information where the payment codes, the administrator IDs, the charges, and computer IDs as identification information of the computer, are matched.

The following describes operations of the document printing system 10.

First, a description will be given of the operation of the document printing system 10 when the printer driver 35b is installed onto the electronic device 30.

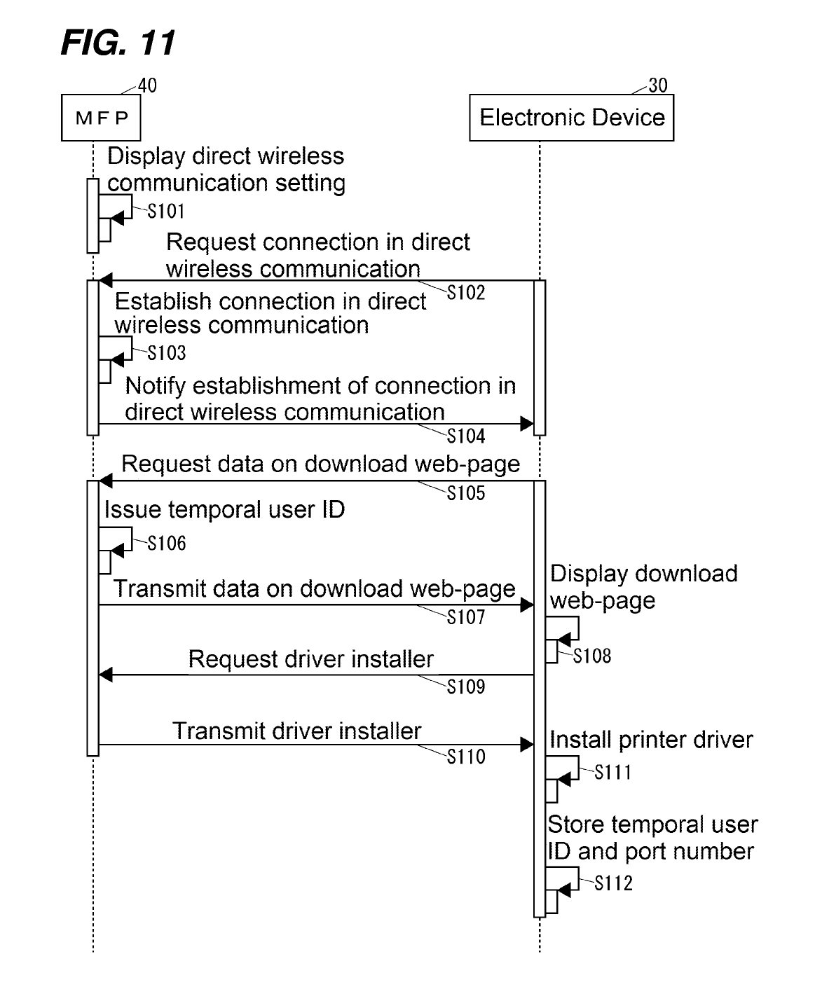

FIG. 11 illustrates the operation of the document printing system 10 when the printer driver 35b is installed onto the electronic device 30.

The user can instruct the MFP 40 to display a setting (hereinafter referred to as “a direct wireless communication setting”) for the direct wireless communication with the MFP 40 via the operation unit 41.

When the display of the direct wireless communication setting is instructed, as illustrated in FIG. 11, the wireless communication unit 48a of the MFP 40 displays the direct wireless communication setting on the display 42 (Step S101). Accordingly, the user can input the direct wireless communication setting displayed on the display 42 to the electronic device 30 via the operation unit 31 as a setting for the wireless communication.

When the direct wireless communication setting is input as the setting for the wireless communication, the control unit 35 of the electronic device 30 uses the input direct wireless communication setting to request the MFP 40 for connection in the direct wireless communication (Step S102). Accordingly, the wireless communication unit 48a of the MFP 40 establishes the connection with the electronic device 30 in the direct wireless communication (Step S103), and notifies the establishment of the connection in the direct wireless communication to the electronic device 30 (Step S104).

After this, the electronic device 30 and the MFP 40 can send and receive the information by the direct wireless communication.

After the establishment of the connection between the electronic device 30 and the MFP 40 in the direct wireless communication, the user can instruct a display of a web page (hereinafter referred to as “a download web-page”) to download the driver installer 47b via the operation unit 31.

When the display of the download web-page is instructed, the web browser 35a of the electronic device 30 requests the MFP 40 for data on the download web-page via the direct wireless communication (Step S105). Therefore, the print data management unit 48b of the MFP 40 issues the temporal user ID (Step S106), and transmits the data on the download web-page, which includes the temporal user ID issued in Step S106 and a port number to accept the print data, to the electronic device 30 via the direct wireless communication (Step S107). Accordingly, the web browser 35a of the electronic device 30 displays the download web-page on the display 32 based on the data on the download web-page received from the MFP 40 (Step S108).

The user can instruct the download of the driver installer 47b on the download web-page displayed on the display 32 via the operation unit 31.

When the download of the driver installer 47b is instructed on the download web-page, the web browser 35a of the electronic device 30 requests the MFP 40 for the driver installer 47b instructed to be downloaded via the direct wireless communication (Step S109). Therefore, the print data management unit 48b of the MFP 40 transmits the driver installer 47b requested from the electronic device 30 to the electronic device 30 via the direct wireless communication (Step S110).

When the driver installer 47b is transmitted from the MFP 40 in Step S110, the control unit 35 of the electronic device 30 causes the driver installer 47b transmitted from the MFP 40 to operate, thus installing the printer driver 35b onto the electronic device 30 (Step S111). That is, the control unit 35 causes the storage unit 34 to store the printer driver program 34b.

After the process in Step S111, the user can set the temporal user ID and the port number, which have been displayed on the download web-page in Step S108, on the printer driver 35b via the operation unit 31. Accordingly, the printer driver 35b stores the temporal user ID and the port number set via the operation unit 31 (Step S112).

The following describes the operation of the document printing system 10 when new print data 47c is stored in the MFP 40.

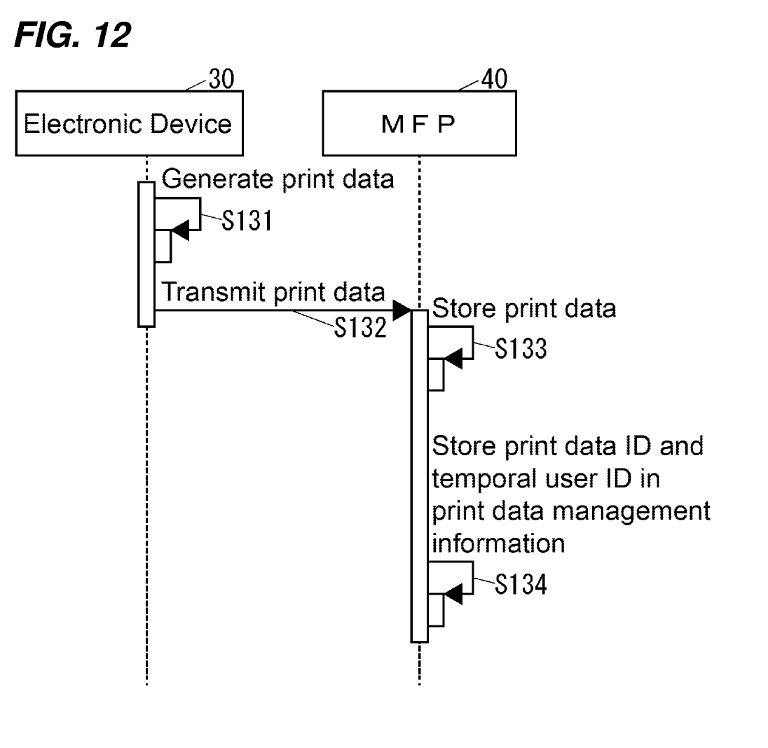

FIG. 12 illustrates the operation of the document printing system 10 when new print data 47c is stored in the MFP 40.

The user can instruct the printer driver 35b to transmit the print data to the MFP 40 via the operation unit 31. Here, the user can instruct the generation of the print data not only on the document stored in the electronic device 30 but also documents that are accessible from the electronic device 30 and outside the electronic device 30, for example, documents stored in a USB flash drive and an SD card connected to the electronic device 30.

When the transmission of the print data to the MFP 40 is instructed, as illustrated in FIG. 12, the printer driver 35b generates the print data (Step S131). Here, the printer driver 35b can change the print setting applied to the document in the generation of the print data corresponding to the instruction via the operation unit 31. When an inconsistent setting is included between the print setting included in the document itself and the print setting instructed via the operation unit 31, the printer driver 35b prioritizes the print setting instructed via the operation unit 31. For example, when the print setting included in the document itself includes a setting of a color printing, and the print setting instructed via the operation unit 31 includes a setting of a monochrome printing, the printer driver 35b employs the information indicating the monochrome printing as color information to include in the print data.

Subsequently, the printer driver 35b associates the print data generated in Step S131 to the temporal user ID stored in Step S112 to transmit to a port of the port number of the MFP 40 stored in Step S112 (Step S132). Therefore, the print data management unit 48b of the MFP 40 accepts the print data transmitted from the electronic device 30 to store in the storage unit 47 as the print data 47c (Step S133), and matches the print data ID of the print data 47c with the temporal user ID associated with the print data 47c to store in the print data management information 47d (Step S134).

The user repeats the above-described operation to ensure storing print data of a plurality of documents in the MFP 40 using the printer driver 35b.

The following describes the operation of the document printing system 10 until the MFP 40 to which an instruction of an execution of a document print job has been input displays a two-dimensional code.

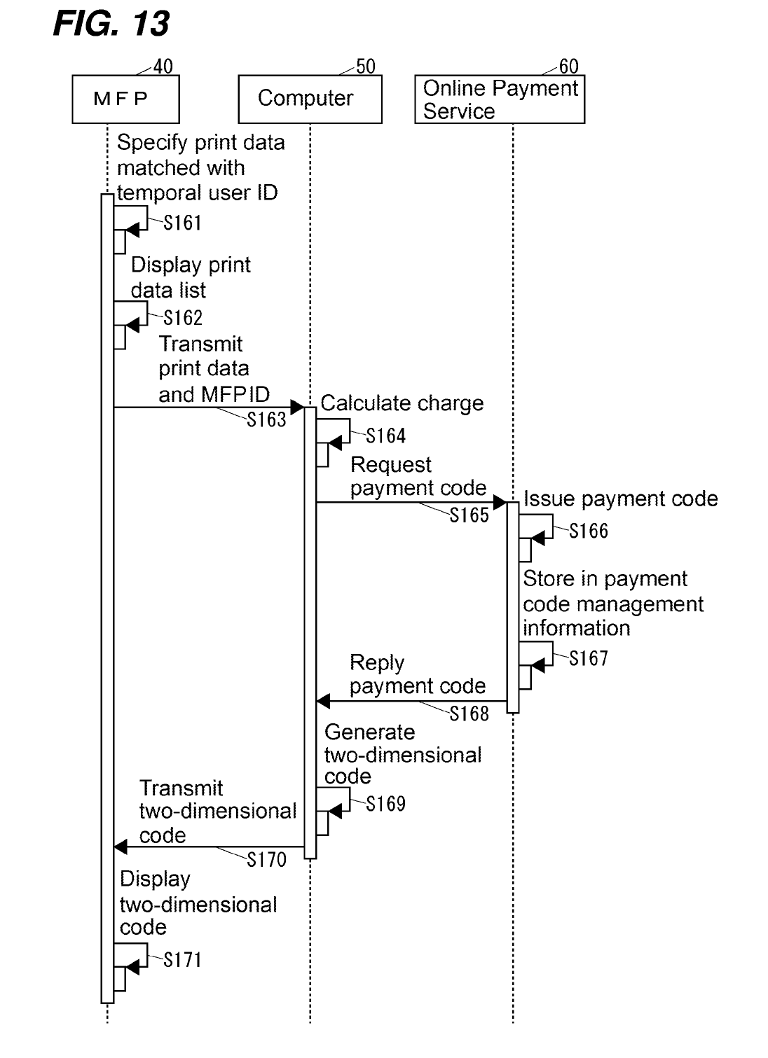

FIG. 13 illustrates the operation of the document printing system 10 until the MFP 40 to which the instruction of the execution of the document print job has been input displays the two-dimensional code.

After the print data 47c is stored in the MFP 40, the user can login to the MFP 40 via the operation unit 41. Here, the user can login to the MFP 40 with the temporal user ID included on the download web-page displayed on the display 32 in Step S108.

When the user has logged in with the temporal user ID via the operation unit 41, as illustrated in FIG. 13, the print data designation accepting unit 48c of the MFP 40 specifies the print data 47c, which is matched with the temporal user ID of the user who has logged in and stored in the MFP 40, based on the print data management information 47d (Step S161), and displays a list (hereinafter referred to as “a print data list”) of the specified print data 47c on the display 42 (Step S162).

The user can choose the print data 47c that the user desires to print from the print data list displayed on the display 42 in Step S162 via the operation unit 41.

When the print data 47c that the user desires to print is chosen via the operation unit 41, the print data designation accepting unit 48c transmits the chosen print data 47c and the MFPID of the MFP 40 to the computer 50 (Step S163).

After the process in Step S163, the charge calculator 53a of the computer 50 calculates the charge of a current document print job based on the print data transmitted from the MFP 40 in Step S163 and a specific calculation criterion (Step S164).

The print data includes various information necessary for calculating the charge, for example, number-of-pages information indicative of the number of pages to be printed, number information indicative of the number of printed recording medium, recording medium size information indicative of a size of the printed recording medium, color information indicative of whether to execute any of a monochrome printing and a color printing, and double-side/single-side information indicative of whether to execute any of a duplex printing and a single-side printing. The number-of-pages information and the number information are decided based on, for example, the number of pages of the document and various print settings such as the setting of the number of copies included in the print setting of the document and the setting whether to execute any of the duplex printing and the single-side printing.

For example, when the print setting is set to the duplex printing, the print job is executed on the recording medium of a half of the number of pages of the print data 47c per copy. The charge calculator 53a may reflect the number on the charge.

When the print setting is set to a plurality of number of copies, the print job is executed on printing surfaces by the number obtained by multiplying the number of printing surfaces of the recording medium for one copy of the print data 47c by the number of copies. The charge calculator 53a may reflect the number of the printing surfaces on the charge.

After the process of Step S164, the payment communication unit 53b of the computer 50 requests a payment code of the charge calculated in Step S164 to the online payment service 60 (Step S165). Here, the payment communication unit 53b includes the administrator ID, which is matched with the MFPID transmitted from the MFP 40 with the print data in Step S163 in the MFP management information 52b, and the computer ID of the computer 50 into the request in Step S165.

Accordingly, the online payment service 60 issues the payment code corresponding to the request in Step S165 (Step S166), subsequently matches the issued payment code with the administrator ID, the charge, and the computer ID, which are included in the request in Step S165, to store in the payment code management information 60c (Step S167), and replies the issued payment code to the computer 50 (Step S168).

The payment communication unit 53b of the computer 50 generates a two-dimensional code such as a QR code (registered trademark) that indicates the payment code replied from the online payment service 60 in Step S168 (Step S169). The payment communication unit 53b matches the payment code replied from the online payment service 60 in Step S168 with the print data ID of the print data transmitted from the MFP 40 in Step S163 and the MFPID transmitted from the MFP 40 with the print data in Step S163, so as to store in the payment code management information 52c.

Next, the payment communication unit 53b transmits the two-dimensional code generated in Step S169 to the MFP 40 (Step S170).

Accordingly, the payment code notification unit 48d of the MFP 40 displays the two-dimensional code transmitted from the computer 50 in Step S170 on the display 42 (Step S171).

The following describes the operation of the document printing system 10 from when the user terminal 20 reads the two-dimensional code until the MFP 40 terminates the execution of the document print job.

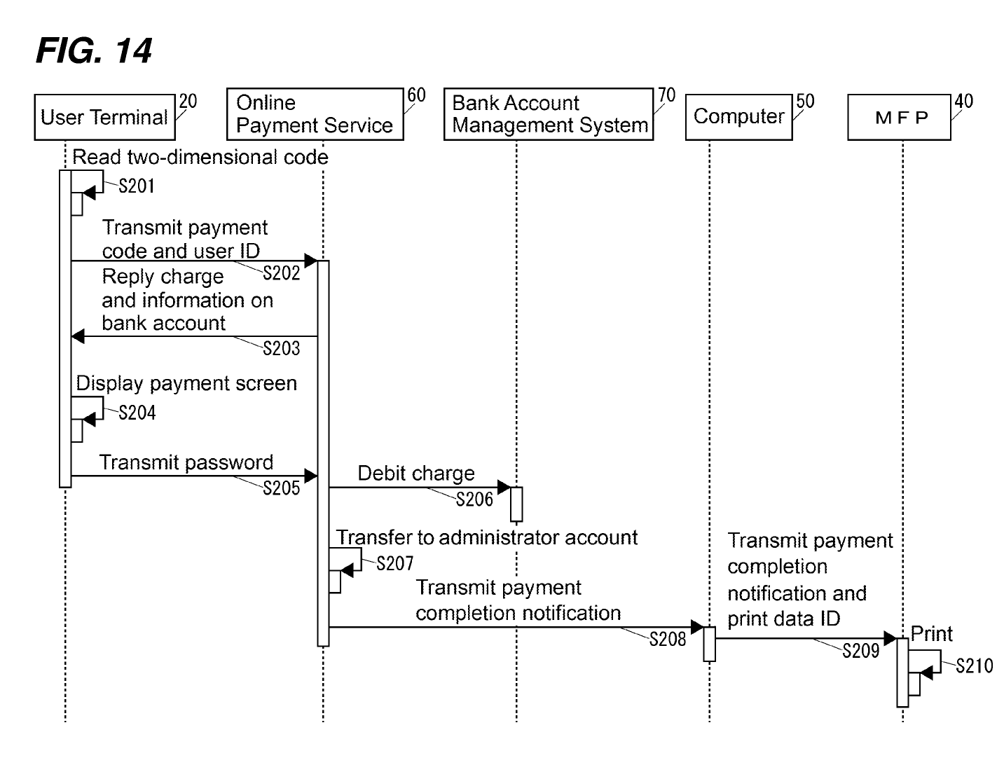

FIG. 14 illustrates the operation of the document printing system 10 from when the user terminal 20 reads the two-dimensional code until the MFP 40 terminates the execution of the document print job.

The user can operate the user terminal 20 so as to cause the capturing unit 23 of the user terminal 20 to read the two-dimensional code displayed on the display 42 of the MFP 40 in Step S171. When the user terminal 20 is operated so as to cause the capturing unit 23 to read the two-dimensional code displayed on the display 42, as illustrated in FIG. 14, the payment instruction unit 26a of the user terminal 20 reads the two-dimensional code displayed on the display 42 by the capturing unit 23 (Step S201).

Subsequently, the payment instruction unit 26a interprets the two-dimensional code read in Step S201, and transmits the payment code indicated by the two-dimensional code and the user ID of the user logged in to the user terminal 20 to the online payment service 60 (Step S202).

Accordingly, the online payment service 60 replies the charge, matched with the payment code in the payment code management information 60c, and the information on the bank account, associated with the user ID in the user bank account information 60a, to the user terminal 20 based on the payment code and the user ID transmitted from the user terminal 20 in Step S202 (Step S203).

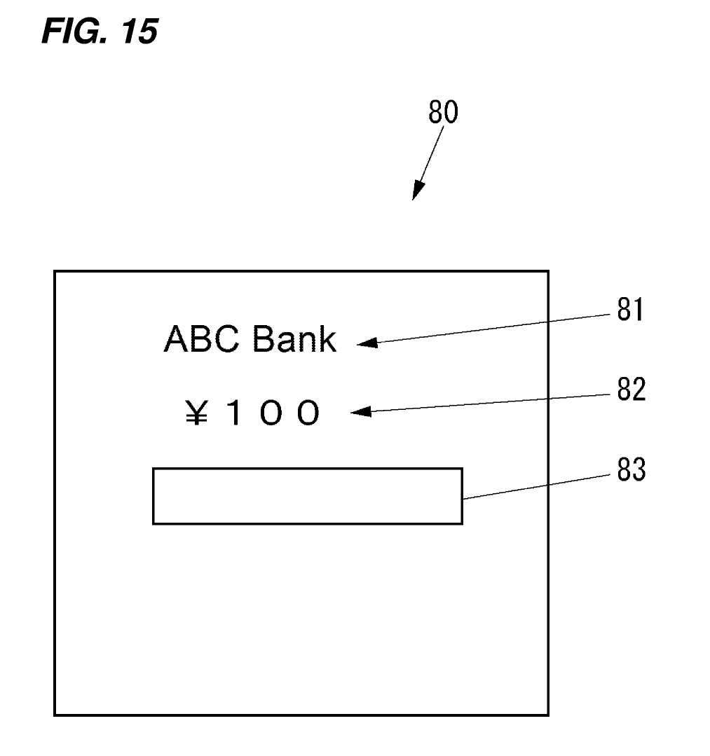

When the charge and the information on the bank account are transmitted from the online payment service 60, the payment instruction unit 26a of the user terminal 20 displays a payment screen 80 (see FIG. 15) to pay for the charge on the display 22 (Step S204).

FIG. 15 illustrates an exemplary payment screen 80.

As illustrated in FIG. 15, the payment screen 80 includes a text 81, a text 82, and a text box 83. The text 81 indicates the information on the bank account transmitted from the online payment service 60. The text 82 indicates the charge transmitted from the online payment service 60. To the text box 83, a password for the bank account, that is, a password to permit a debit from the bank account by the bank account management system 70 is input.

FIG. 15 shows a name of a bank as the information on the bank account displayed in the payment screen 80. However, as the information on the bank account, the payment screen 80 may display the information other than the name of the bank in addition to the name of the bank or instead of the name of the bank. At Step S203, it is only necessary that only the information displayed in the payment screen 80 is replied among the information on the bank account.

As illustrated in FIG. 14, when the password for the bank account is input to the text box 83, the payment instruction unit 26a transmits the input password to the online payment service 60 (Step S205).

Accordingly, only when the password transmitted from the user terminal 20 at Step S205 is correct, the online payment service 60 debits the charge, matched with the payment code transmitted from the user terminal 20 at Step S202 in the payment code management information 60c, from the bank account, associated with the user ID transmitted from the user terminal 20 at Step S202 in the user bank account information 60a, among the bank accounts managed by the bank account management system 70 (Step S206).

Next, the online payment service 60 transfers the charge debited at Step S206 to the account associated with the administrator ID, which is matched with the payment code transmitted from the user terminal 20 at Step S202 in the payment code management information 60c, in the administrator account information 60b (Step S207).

Next, the online payment service 60 transmits a payment completion notification indicative of the completion of the payment for the charge and the payment code transmitted from the user terminal 20 at Step S202 to the computer 50 with the computer ID matched with this payment code in the payment code management information 60c (Step S208).

When the payment completion notification and the payment code are transmitted from the online payment service 60 at Step S208, the payment communication unit 53b in the computer 50 transmits the payment completion notification and the print data ID, which is matched with the payment code transmitted with the payment completion notification from the online payment service 60 in Step S208 in the payment code management information 52c, to the MFP 40 with the MFPID matched with this payment code in the payment code management information 52c (Step S209).

When the payment completion notification and the print data ID are transmitted from the computer 50 at Step S209, the document printing unit 48e in the MFP 40 executes the print job by the printer 44 based on the print data 47c of this print data ID among the print data 47c stored in the storage unit 47 (Step S210).

As described above, in the document printing system 10, accurate charge based on the print data is paid (Steps S205 to S207), and subsequently, the print job is executed based on this print data (Step S210). Then, the execution of the document print job as “to execute printing of document” is not halted in its course due to a delay of payment for the charge, thus ensuring the improvement of convenience.

Since the document printing system 10 uses the online payment service 60, not a coin vendor, to pay for the charge, the charge is directly transferred from the bank account of the user of the MFP 40 to the account of the administrator of the MFP 40. This eliminates the need for acquisition work of the charge from the coin vendor, thus ensuring reduction in labor costs and safety reception of the charge.

Since the document printing system 10 uses the online payment service 60, not the coin vendor, to pay for the charge, the document printing system 10 can be easily introduced to countries where the coin vendors are not used so much.

In the document printing system 10, the driver installer 47b is transmitted from the MFP 40 to the external electronic device 30 via the direct wireless communication (Step S110). Then, even if the MFP 40 is not connected to the network to which a plurality of external electronic devices connect, the MFP 40 accepts the print data via the printer driver 35b installed onto the electronic device 30 (Steps S132 to S133). Accordingly, the document printing system 10 can prevent the MFP 40 from executing a print job that corresponds to an instruction via the network to which the plurality of external electronic devices connect, for example, a print job based on print data unrelated to the payment for the charge using the online payment service 60.

In the MFP 40 of the document printing system 10, the print data management unit 48b notifies the temporal user ID as the identification information matched to the print data 47c (Step S107), and the payment code notification unit 48d notifies the payment code of the print data 47c which is matched with the temporal user ID and accepted the designation by the print data designation accepting unit 48c (Step S171). With this configuration, the document printing system 10 notifies only the payment code of the print data matched with the temporal user ID designated by the user. Then, the document printing system 10 can execute only the print job based on the print data recognized by the user, thus ensuring the improvement of convenience.

In the document printing system 10, the MFP 40 notifies the payment code by displaying on the display 42 (Step S171). Then, even if the user terminal 20 and the MFP 40 cannot mutually communicate, the payment code displayed on the display 42 of the MFP 40 can be used to pay for the charge by the user terminal 20 via the online payment service 60.

In the document printing system 10, the payment code is compactly displayed as the two-dimensional code on the display 42 of the MFP 40. Then, the payment code is easily captured by the capturing unit 23 of the user terminal 20, thus ensuring the improvement of convenience. The document printing system 10 may display the payment code on the display 42 with a method where it is difficult for the capturing unit 23 of the user terminal 20 to capture the payment code compared with the two-dimensional code, for example, a character string and a one-dimensional code.

In the document printing system 10, the payment code displayed on the display 42 is obtained by capturing by the capturing unit 23, thus eliminating the need for manually inputting the payment code displayed on the display 42 of the MFP 40 to the user terminal 20 by the user of the user terminal 20. Accordingly, the document printing system 10 ensures the improvement of convenience. When the document printing system 10 displays the payment code on the display 42 with not the two-dimensional code but a method, such as a character string, understandable for the user of the user terminal 20, the document printing system 10 may have a configuration where the payment code displayed on the display 42 of the MFP 40 is manually input to the user terminal 20 by the user of the user terminal 20.

In the embodiment, the document printing system 10 uses the account managed by the online payment service 60 as the account of the administrator of the MFP 40. However, the document printing system 10 may have a configuration that uses the bank account, not the account managed by the online payment service 60, as the account of the administrator of the MFP 40.

In the embodiment, the document printing system 10 uses the bank account as the account of the user of the MFP 40. However, the document printing system 10 may have a configuration that uses the account managed by the online payment service 60, not the bank account, as the account of the user of the MFP 40.

In the embodiment, the document printing system 10 includes the MFP 40 that manages the print data transmitted from the electronic device 30 to the MFP 40. However, the document printing system 10 may include the computer 50 that manages the print data transmitted from the electronic device 30 to the MFP 40.

The document printing system 10 may have a configuration where the MFP 40 achieves at least a part of the above-described functions of the computer 50 by executing the document print program 47a. For example, the document printing system 10 may have a configuration where the MFP 40 achieves the function corresponding to the charge calculator 53a of the computer 50. In a configuration where the MFP 40 achieves every above-described function of the computer 50, the document printing system 10 may omit the computer 50.

In the embodiment, the document printing system 10 includes the user terminal 20 and the electronic device 30 as separate devices. However, in the document printing system 10, the user terminal 20 and the electronic device 30 may be achieved by one device.

While the image forming apparatus of the disclosure is the MFP in the embodiment, the image forming apparatus may be an image forming apparatus other than the MFP, for example, a printer-only machine.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A document printing system comprising:
an image forming apparatus that includes
a print device, and
a driver installer that installs a printer driver onto an external electronic device, the printer driver generating print data of a document;
a print data management unit that manages the print data generated by the printer driver;
a charge calculator that calculates a charge based on the print data managed by the print data management unit; and
a payment code notification unit that notifies a payment code issued by an online payment service to the charge calculated by the charge calculator; wherein
the image forming apparatus includes a document printing unit that executes a print job with the print device based on the print data managed by the print data management unit when the charge has been paid via the online payment service using the payment code notified by the payment code notification unit.

2. The document printing system according to claim 1, wherein:
the image forming apparatus includes a wireless communication unit configured to execute direct wireless communication with the electronic device without being via another communication device; and
the driver installer is transmitted from the image forming apparatus to the electronic device via the wireless communication executed by the wireless communication unit.

3. The document printing system according to claim 1, wherein:
the print data management unit notifies identification information to be matched with the print data;
the image forming apparatus includes a print data designation accepting unit that accepts a designation of the print data matched with the identification information; and
the payment code notification unit notifies the payment code of the print data where the designation has been accepted by the print data designation accepting unit.

4. The document printing system according to claim 1, wherein:
the image forming apparatus includes a display device; and
the payment code notification unit notifies the payment code by displaying on the display device.

5. The document printing system according to claim 4, further comprising:
a user terminal to pay the charge via the online payment service using the payment code notified by the payment code notification unit; wherein
the user terminal includes a capturing device and obtains the payment code displayed on the display device by capturing with the capturing device.

6. The document printing system according to claim 5, wherein the payment code notification unit displays the payment code as a two-dimensional code on the display device.

7. An image forming apparatus comprising:
a print device;
a driver installer that installs a printer driver onto an external electronic device, the printer driver generating print data of a document;
a print data management unit that manages the print data generated by the printer driver;
a payment code notification unit that notifies a payment code issued to a charge by an online payment service, the charge being based on the print data managed by the print data management unit; and
a document printing unit that executes a print job with the print device based on the print data managed by the print data management unit when the charge has been paid via the online payment service using the payment code notified by the payment code notification unit.

8. A non-transitory computer-readable recording medium storing a document print program, the document print program causing an image forming apparatus that includes a print device to function as:
a driver installer that installs a printer driver onto an external electronic device, the printer driver generating print data of a document;
a print data management unit that manages the print data generated by the printer driver;
a payment code notification unit that notifies a payment code issued to a charge by an online payment service, the charge being based on the print data managed by the print data management unit; and
a document printing unit that executes a print job with the print device based on the print data managed by the print data management unit when the charge has been paid via the online payment service using the payment code notified by the payment code notification unit.
